(19) United States
(12) Patent Application Publication
(10) Pub. No.: US 2012/0139888 A1
(43) Pub. Date: Jun. 7, 2012

(54) DISPLAY SYSTEM

(75) Inventor: Hideo Fujimori, Osaka (JP)

(73) Assignee: SANYO ELECTRIC CO., LTD., Moriguchi City (JP)

(21) Appl. No.: 13/308,175

(22) Filed: Nov. 30, 2011

(30) Foreign Application Priority Data
Nov. 30, 2010 (JP) 2010-266516

(51) Int. Cl. G09G 5/00

(52) U.S. Cl. 345/211

(57) ABSTRACT

A display system has a solar cell; a battery unit storing an electric power; a display apparatus which displays image; a controller which controls the power supply of the electricity generated by the solar cell to the display apparatus and the battery unit, the controller further controls the power supply from the battery unit to the display apparatus, and a receiving unit which receives a weather information, wherein the controller controls the percentage among the power supplying to the display apparatus and the battery unit according to the weather information received by the receiving unit.

### CROSS-REFERENCE TO RELATED APPLICATIONS

This application is based on Japanese Patent Application No. 2010-266516 filed on Nov. 30, 2010, the contents of which are hereby incorporated by reference.

### BACKGROUND OF THE INVENTION

1. Field of the Invention

The present invention relates to the outdoor display system equipped with the solar cell.

2. Description of the Related Art

In recent years, an outdoor-use large-sized display so called “digital signage” which displays an advertisement or information is increasing.

There exists a system in which a solar cell and a storage battery are integrated to the above-mentioned display. In such system, a power is supplied to the display from the solar cell, while the surplus power is supplied to the storage battery.

In such system, it needs to supply power from the storage battery to the display because the solar cell cannot generate power in rainy weather. However, when this weather continues for a long time, the residual charged power in the battery becomes less and thus it may be unable to drive the display.

### SUMMARY OF THE INVENTION

A display system according to the present invention comprises,
a solar cell;
a battery unit storing an electric power;
a display apparatus which displays image;
a controller which controls the power supply of the electricity generated by the solar cell to the display apparatus and the battery unit, the controller further controls the power supply from the battery unit to the display apparatus, and
a receiving unit which receives a weather information, wherein
the controller controls the percentage among the power supplying to the display apparatus and the battery unit according to the weather information received by the receiving unit.

### DESCRIPTION OF THE DRAWINGS

FIG. 1 is a front perspective view of the outdoor display system 100.

FIG. 2 is a block diagram showing an electric circuit of the outdoor display system 100.

FIG. 3 shows an electric circuit in the controller 40.

FIG. 4 is a flow chart showing an example of control performed by the outdoor display system 100.

FIG. 5 is a flow chart showing another example of control performed by the outdoor display system 100.

### DESCRIPTION OF THE PREFERRED EMBODIMENTS

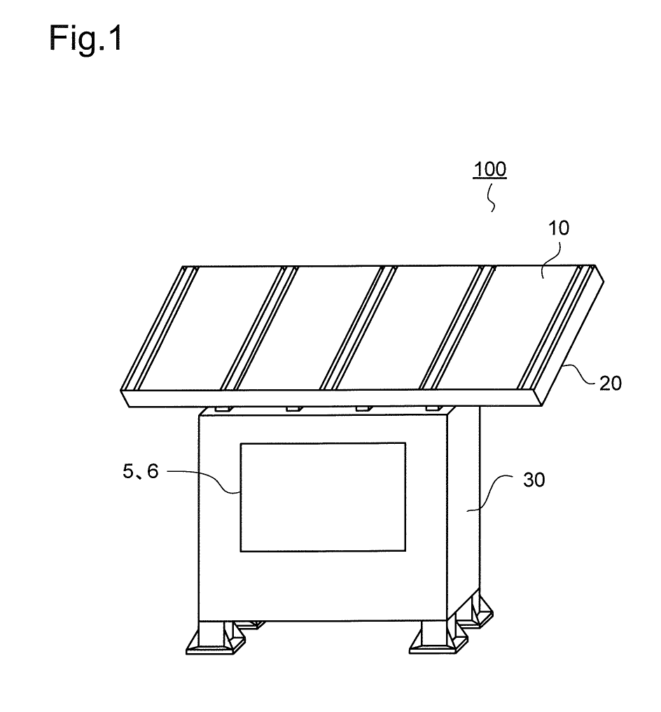

The embodiment of the present invention is explained below. FIG. 1 is a front perspective view of the outdoor display system 100.

The outdoor display system 100 has a solar cell 10, an installation stand 20, and a display 30. Further, although it is not illustrated in FIG. 1 since they are in a hidden position, the system 100 also has a controller and a storage battery arranged on the back side of the display 30.

The solar cell 10 is installed on the installation stand 20 arranged on the display 30. The cell 10 generates electricity by photo-electric conversion of the sunlight. The electric power obtained by the cell 10 is stored in the storage battery via the controller. The storage battery is a lithium ion battery, for example.

The display 30 contains a display panel, such as a liquid crystal display panel (LCD), and displays contents transmitted from an external contents server or a broadcasting station. The display 30 also has a touch panel 6 in which the use can make touch operation.

The display 30 has also an antenna which receives contents by wireless or a receiving unit which receives the contents by cables (for example, Ethernet cable).

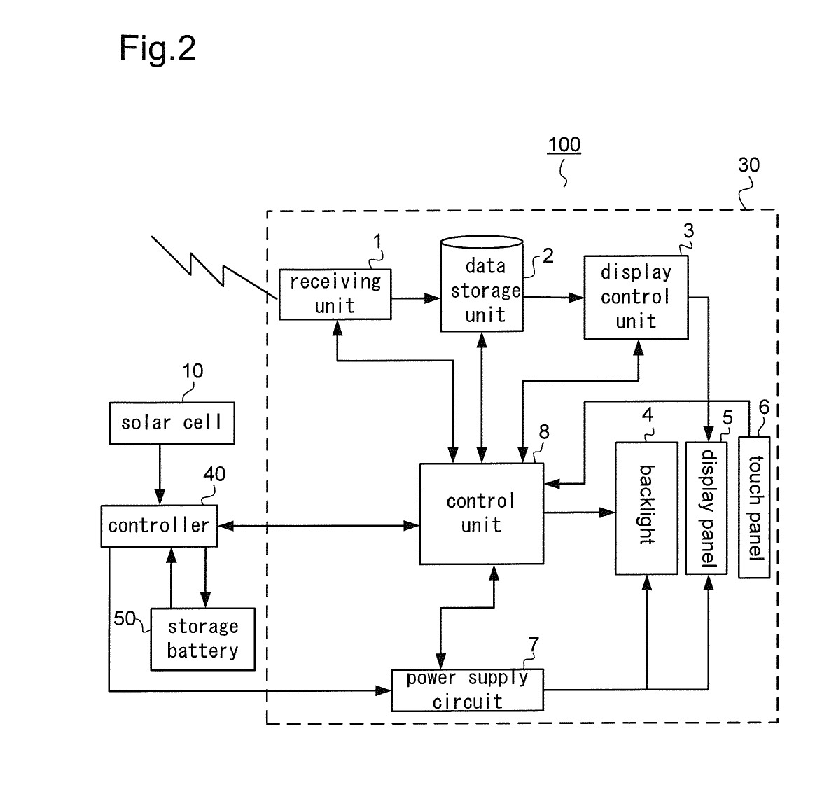

FIG. 2 is a block diagram showing an electric circuit of the outdoor display system 100. As shown in the figure, the display 30 has a receiving unit 1, a data storage unit 2, a display control unit 3, a back light 4, the display panel 5, the touch panel 6, a power supply circuit 7, and a control unit 8.

The controller 40 supplies an electric power generated by the solar cell 10 to the display 30 and the storage battery 50. Basically, the controller 40 supplies most of the power to the display 30. The surplus electric power is supplied to the battery 50. In nighttime or in rainy weather, the controller 40 controls so that the electric power is supplied from the battery 50 to the display 30. In this case, the electric power stored in the battery 50 is transmitted to a display 30 via the controller 40.

The control unit 8 is constituted by CPU, for example, and controls each portion of the display 30 or collects the state information of these portions.

The display panel 5 is a portion which actually displays an image, and a liquid-crystal-display panel is used here.

A backlight 4 irradiates the display panel 5. A cold cathode pipe (CCFL) or an LED light source are used, for example, as the backlight 4. For conserving power consumption, the LED light source is desirable.

A touch panel 6 is a transparent electric capacity type touch sensor arranged in front side of the display panel 5. This touch panel 6 accepts an input from a user. For example, when the display panel 5 is showing a plurality of button images (icons) so as to let user make multiple choice, it is regarded that the user has made a selection when the user touch the position in the touch panel 6 corresponding to one of the button image.

The receiving unit 1 has an antenna which receives a signal transmitted by wireless communications (such as WiMAX or IEEE802.11b/g) from external contents servers (an ASP server, a personal computer, etc.) or from broadcasting stations. The unit 1 also has signal-processing unit which demodulate a signal received by the antenna. When the wireless signal is a MPEG 2-TS format signal modulated by an OFDM system, the unit 1 performs an OFDM demodulation and extracts an MPEG 2-TS signal. The extracted MPEG 2-TS signal is outputted to the data storage unit 2. The receiving unit 1 can also receive weather report information which is used for a control mentioned later.

The data storage unit 2 stores the contents extracted by the receiving unit 1 or the weather report information received by the unit 1. When content is real-time content (when the contents is displayed by the display 5 immediately after the reception), the unit 2 functions as a buffer memory. When content is the content displayed triggered by an operation of the user, or content displayed based on a preset time schedule, the accumulation part 2 functions as storage media.

The display control unit 3 performs control such as driving each pixel of the panel 5 in order to display an image. Since the display control unit 3 is required to perform a high-speed processing, this unit is realized by a dedicated hardware circuitry provided separately from the control part 8 constituted by CPU.

The power supply unit 7 supplies power to each of the units in the display 30. In FIG. 2, it is depicted as if unit 7 supplies power only to the display panel 5 and the backlight 4. This is because the panel 5 and the backlight consume large power compared to other units. However, in practice, the circuit 7 also supplies to the other units such as receiving unit 1, the storage unit 2, the display control unit 3, a touch panel 6 as well.

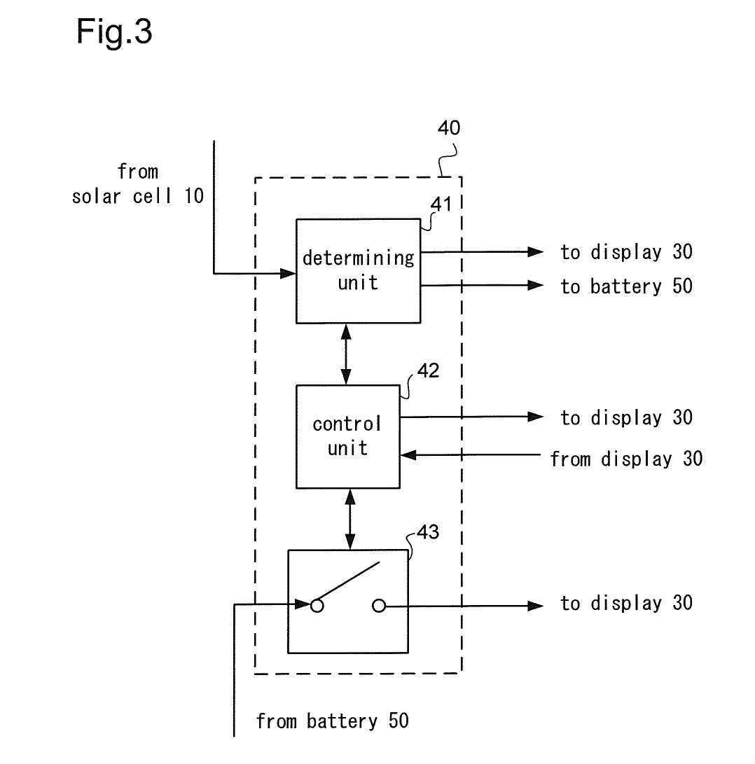

FIG. 3 shows an electric circuit in the controller 40. The controller 40 has a determining unit 41, a control unit 42, and a switch 43. The determining unit 41 is for determining whether the power generated by the solar cell 10 should be outputted to the display 30 or to the storage battery 50. The determining unit 41 is controlled by the control unit 42. The determining unit 41 may be a switch which outputs the power selectively to one of the display 30 or the battery 50. The unit 41 may be a divider which outputs a certain percentage of the power inputted to the unit 41 to the display 30 and rest of the power to the battery 50.

The control unit 42 performs various control executed in the controller 40. The unit 42 also receives control information from the display 30, or transmits a control signal to the display 30.

A switch 43 is for switching whether the electric power stored in the storage battery 50 should be outputted to a display 30 or not.

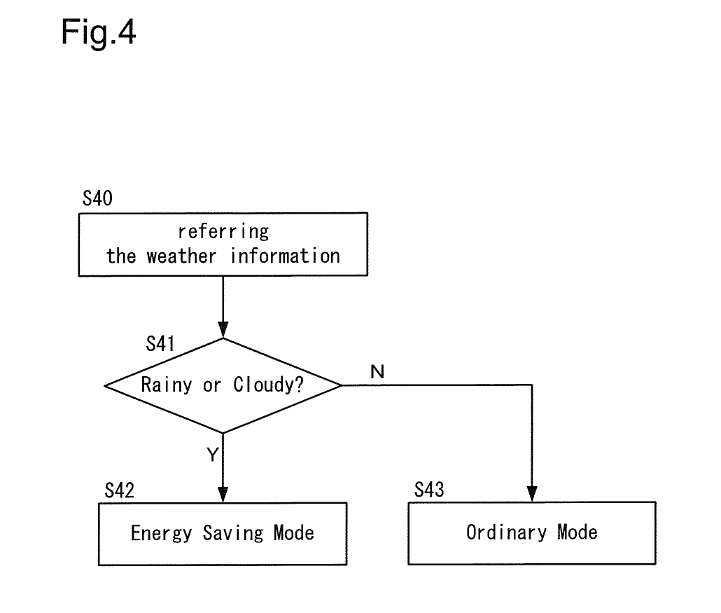

Next, referring to a flow chart shown in FIG. 4, a control which the outdoor display system 100 performs is explained.

First, in Step S40, the control unit 8 read outs weather report information stored in the data storage unit 2, and refers to weather information of the district the outdoor display system 100 is installed. Here, the weather information is either a fine weather, a clouded sky, or a rainy weather.

When the weather information is either a clouded sky, or a rainy weather (when “yes” in S41), assuming that it might turns to the clouded sky, or the rainy weather, the control unit 8 starts operation in an energy-saving mode (step S42). In this mode, the luminosity of the backlight 4 is set to a lower value compared to an ordinary mode. In this case, the control unit 42 of the controller 40 controls the determining unit 41 so as to increase the percentage of the power outputted to the battery 50 out of the power generated by the solar cell 10, triggered by an instruction from the control unit 8.

If weather information is fine weather (“no” in step S41), the control unit 8 starts operating in the ordinary mode (in step S43). In this case, the control unit 42 in the controller 40 controls the determining unit 41 so as to decrease the percentage of the power outputted to the battery out of the power generated by the solar cell 10, triggered by an instruction from the control unit 8.

When the solar cells 10 generates few power or no power, such as in rainy weather, cloudy weather and nighttime, the control unit 42 may control the switch 43 so that the electric power stored in the battery 50 is supplied to the display 30. When the solar cells 10 generates a large power, such as in sunny weather, the control unit 42 may control the switch 43 so that the power stored in the battery 50 is not supplied to the display 30.

As described above, when it is likely to be a rainy or a cloudy weather, the display 30 is set to the energy-saving mode, so that the electric power is stored in the battery 50. Thereby, it can continue driving the display 30 even in the rainy or cloudy weather.

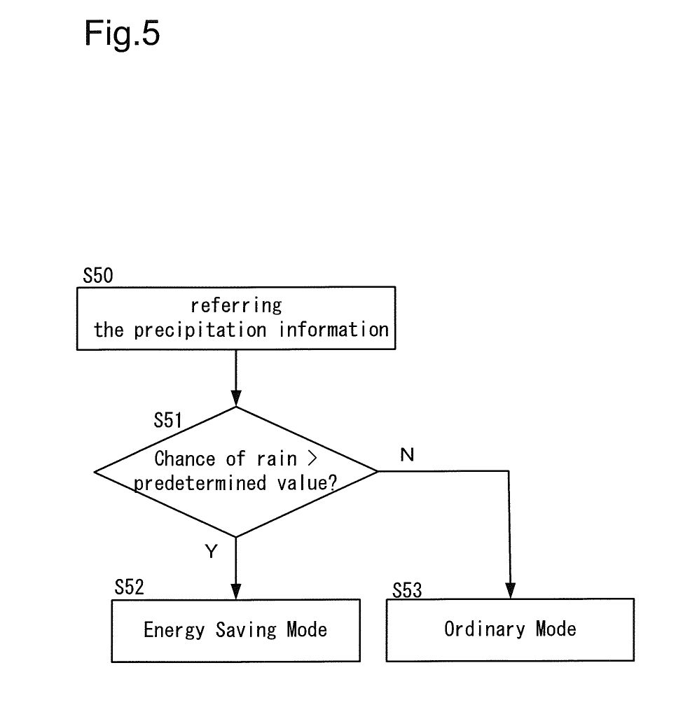

FIG. 5 is a flow chart showing another example of control performed by the outdoor display system 100.

First, in step S50, the control unit 8 read outs the weather report information stored in the data storage unit 2, and refers to the chance of rain information in the installing area of the outdoor display system 100.

When the precipitation percentage is more than a predetermined (ex. 50%) percentage (yes in step S51), assuming that it is likely to be rainy or be cloudy, the control unit 8 starts operating in energy-saving mode (step S52). In this case, the control unit 42 of the controller 40 controls the determining unit 41 so as to increase the percentage of the power outputted to the battery 50 out of the power generated by the solar cell 10, triggered by an instruction from the control unit 8.

When the precipitation percentage is less than the predetermined percentage (no in step S51), the control unit 8 starts operating in the ordinary mode. In this case, the control unit 42 of the controller 40 controls the determining unit 41 so as to decrease the percentage of the power outputted to the battery 50 out of the power generated by the solar cell 10, triggered by an instruction from the control unit 8.

Thereby, it can continue driving the display 30 even in the rainy or cloudy weather.

The embodiment of the present invention is described as above. However, the scope of the present invention is not limited thereto, and the present invention may be implemented by being subjected to various modifications without departing from the gist of the present invention.

For example, the receiving unit 1 for receiving weather report information may be provided inside the controller 40 instead of in the display 30. Or the receiving unit may be a dedicated receiving apparatus provided separated from the display 30 or the controller 40.

In the above example, the display unit of the display 30 is an LCD display panel, however, it may substituted by a plasma panel, an organic electroluminescence panel, an electronic paper, CRT, or an advertising film.

what is claimed is:

1. A display system comprising:
a solar cell;
a battery unit storing an electric power;
a display apparatus which displays image;
a controller which controls the power supply of the electricity generated by the solar cell to the display apparatus and the battery unit, the controller further controls the power supply from the battery unit to the display apparatus, and
a receiving unit which receives a weather information, wherein
the controller controls the percentage among the power supplying to the display apparatus and the battery unit according to the weather information received by the receiving unit.

2. The system according to claim 1, wherein
the display apparatus determines whether to operate in an energy-saving mode or not according to the weather information received by the receiving unit.
